(19) United States
(12) Patent Application Publication
(10) Pub. No.: US 2020/0108831 A1
(43) Pub. Date: Apr. 9, 2020

(54) ADAPTIVE CRUISE CONTROL SYSTEM AND METHOD BASED ON LUMINANCE OF INCIDENT LIGHT

(71) Applicant: Mando Corporation, Pyeongtaek-si (KR)

(72) Inventor: JiYeol PARK, Seoul (KR)

(21) Appl. No.: 16/594,793

(22) Filed: Oct. 7, 2019

(30) Foreign Application Priority Data
Oct. 8, 2018 (KR) 10-2018-0120090

(51) Int. Cl. B60W 30/16

(52) U.S. Cl. CPC B60W 30/162; B60W 2050/143; B60W 2420/40

(57) ABSTRACT

Provided are an adaptive cruise control system and an adaptive cruise control method. The luminance of incident light entering the cabin of a host vehicle is measured. The acceleration and deceleration of the host vehicle and the vehicle-to-vehicle distance between the host vehicle and a preceding vehicle are controlled on the basis of the measured luminance. The safety of a driver may be improved in a situation in which the vision of the driver is obstructed by an excessive intensity of incident light.

### CROSS REFERENCE TO RELATED APPLICATION

This application claims priority from Korean Patent Application 10-2018-0120090, filed on Oct. 8, 2018, which is hereby incorporated by reference for all purposes as if fully set forth herein.

### BACKGROUND

### Field

Embodiments of the present disclosure relate to an adaptive cruise control system and method.

### Description of Related Art

With increasing demand for higher performance in vehicles, as well as for increased convenience and safety of drivers, research and development of driver assistance systems (DAS) for assisting in the controlling of a vehicle, on the basis of information acquired using sensors mounted on the vehicle or information acquired via communications, have been undertaken.

As an example of such driver assistance systems, an adaptive cruise control (ACC) system has been provided to assist a driver of a host vehicle by detecting a speed of a preceding vehicle traveling in front of the host vehicle, a distance to the host vehicle from the preceding vehicle, and the like, and controlling the acceleration and deceleration of the host vehicle on the basis of the driving situation of the preceding vehicle.

If there is no preceding vehicle, the adaptive cruise control system controls the host vehicle to travel at a target speed set by the driver (constant speed driving mode). In contrast, if there is a preceding vehicle, the adaptive cruise control system controls the host vehicle to maintain a suitable distance from the preceding vehicle (guided driving mode).

In addition, an excessive intensity of light, such as direct sunlight, incident on a driver seated within a vehicle may obstruct the vision of the driver. When the vehicle is driven by an adaptive cruise control system, the discomfort of the driver may be increased.

### BRIEF SUMMARY

Various aspects provide an adaptive cruise control system and method able to automatically control the acceleration and deceleration of a host vehicle, a distance between the host vehicle and a preceding vehicle, and the like, in concert with the luminance of incident light entering the cabin of a vehicle.

Also provided are an adaptive cruise control system and method able to assist in safe driving by a driver by automatically controlling a vehicle when an excessive intensity of incident light is detected.

According to embodiments, provided is an adaptive cruise control system including: an excessive incident light detector detecting whether or not incident light entering a host vehicle is excessive; a preceding vehicle detector detecting a preceding vehicle traveling in front of the host vehicle using a sensor provided on the host vehicle; and an acceleration, deceleration, and vehicle-to-vehicle distance controller controlling acceleration and deceleration of the host vehicle and a vehicle-to-vehicle distance between the host vehicle and the preceding vehicle, in accordance with a result of the detection of whether or not the incident light is excessive by the excessive incident light detector.

According to embodiments, provided is an adaptive cruise control system including: an excessive incident light detector detecting whether or not incident light entering the vehicle is excessive; a preceding vehicle detector including an image sensor disposed on the host vehicle to observe the outside of the host vehicle and configured to capture image data; and a domain control unit detecting the preceding vehicle in accordance with at least the processing of the image data and controlling at least one driver assistance system provided in the host vehicle. The domain control unit may control the acceleration and deceleration of the host vehicle and the vehicle-to-vehicle distance between the host vehicle and the preceding vehicle driving in front of the host vehicle, in accordance with the result of the detection of whether or not the incident light is excessive by the excessive incident light detector.

According to embodiments, provided is an image sensor disposed on a host vehicle to have the vision of the outside of a host vehicle in order to capture image data. The image data may be processed by a processor to be used, together with the result of the detection of whether or not the incident light is excessive, to control acceleration and deceleration of the host vehicle and a vehicle-to-vehicle distance between the host vehicle and a preceding vehicle traveling in front of the host vehicle.

According to embodiments, provided is an adaptive cruise control method including: detecting whether or not incident light entering a host vehicle is excessive; and controlling acceleration and deceleration of the host vehicle and a vehicle-to-vehicle distance between the host vehicle and a preceding vehicle, in accordance with a result of the detection of whether or not the incident light is excessive.

According to exemplary embodiments, when an excessive intensity of incident light enters the cabin of a host vehicle, the host vehicle can be automatically decelerated to increase a distance from a preceding vehicle, thereby improving the safety of a driver in a situation in which the vision of a driver may be obstructed by the excessive intensity of incident light.

According to exemplary embodiments, in a situation in which the luminance of incident light is excessive, a sun visor may be operated so that the vision of the driver may not be obstructed, thereby assisting in safe driving by the driver.

According to exemplary embodiments, when the luminance of incident light is excessive, an alarm message may be output to attract the attention of the driver, so that the driver can drive safely.

### DESCRIPTION OF DRAWINGS

The above and other objects, features, and advantages of the present disclosure will be more clearly understood from the following detailed description, taken in conjunction with the accompanying drawings, in which:

FIG. 1 is a block diagram illustrating an adaptive cruise control system according to an embodiment;

FIG. 2 is a block diagram of the acceleration, deceleration, and vehicle-to-vehicle distance setter illustrated in FIG. 1;

FIG. 3 is a flowchart illustrating an adaptive cruise control method of the adaptive cruise control system according to the embodiment;

FIG. 4 is a block diagram illustrating an adaptive cruise control system according to another embodiment; and

FIG. 5 is a flowchart illustrating an adaptive cruise control method of the adaptive cruise control system according to the other embodiment.

### DETAILED DESCRIPTION

Hereinafter, some embodiments of the present disclosure will be described in detail with reference to the accompanying illustrative drawings. However, it is not intended to limit embodiments of the present disclosure to such specific forms, but all modifications, equivalents, and substitutions are possible without departing from the technical idea and scope of the present disclosure. In the following description of the present disclosure, detailed descriptions of known technical features will be omitted in the case in which the concepts of embodiments of the present disclosure may be rendered unclear thereby. In addition, singular forms used in the specification and the Claims are intended to mean “one or more” unless the context clearly indicates otherwise.

Hereinafter, in the following description of embodiments of the present disclosure, the same reference numerals and signs can be used to designate the same or like components, and repetitive descriptions thereof will be omitted.

Prior to the following description with reference to the drawings, terms used in the following description will be defined as follows.

The term “host vehicle” means a vehicle in which an adaptive cruise control system according to embodiments of the present disclosure is provided. The term “preceding vehicle” means a vehicle that the host vehicle follows. That is, the preceding vehicle travels in front of the host vehicle or in front and to the side of the host vehicle.

The term “vehicle-to-vehicle distance” means a distance between the host vehicle and the preceding vehicle. The term “relative speed of the preceding vehicle” means a speed of the preceding vehicle with respect to the speed of the host vehicle.

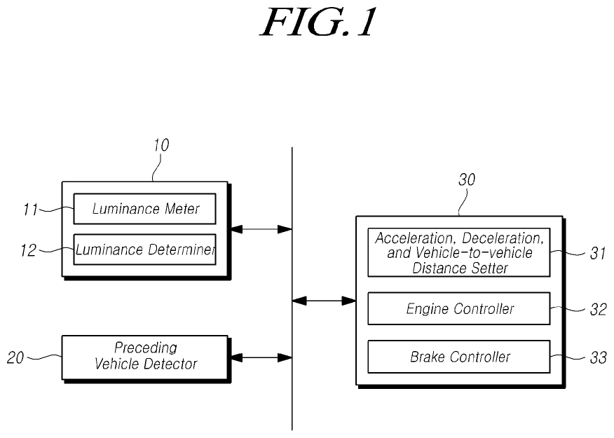

FIG. 1 is a block diagram illustrating an adaptive cruise control system according to an embodiment.

Referring to FIG. 1, the adaptive cruise control system according to the embodiment includes: an excessive incident light detector 10 detecting whether or not excessive incident light enters the cabin of a host vehicle; a preceding vehicle detector 20 detecting a preceding vehicle traveling in front of the host vehicle using a sensor provided on the host vehicle; and an acceleration, deceleration, and vehicle-to-vehicle distance controller 30 controlling the acceleration and deceleration of the host vehicle and the vehicle-to-vehicle distance between the host vehicle and the preceding vehicle on the basis of a result of the detection of the excessive incident light by the excessive incident light detector 10.

The excessive incident light detector 10 may include a luminance meter 11 and an excessive luminance determiner 12.

The luminance meter 11 may measure a value of luminance of incident light entering the cabin of the host vehicle. The luminance meter 11 may be implemented as a luminance sensor, and may be disposed on a room mirror of the host vehicle. The location on which the luminance meter 11 is mounted is not limited to the room mirror. The luminance meter 11 may be disposed on any portion within the host vehicle, as long as the luminance meter 11 can measure the luminance of incident light entering the host vehicle, in particular, incident on the driver seated of the host vehicle.

Alternatively, the luminance may be measured by detecting a variation in the size of a pupil of the driver of the host vehicle using image information received from a camera sensor capturing images of the driver. For example, the luminance meter 11 may detect variations in the luminance depending on variations in the size of the pupil of the driver by detecting the pupil of the driver from the images captured at predetermined time intervals. The luminance meter 11 may measure the luminance depending on the size of the pupil, using a luminance table previously mapped and set depending on the size of the pupil of the driver.

Alternatively, the luminance meter 11 may measure the luminance by detecting variations in the facial expression or the changes in the size of the driver's eyes using image information received from the camera sensor capturing the driver of the host vehicle. For example, the luminance meter 11 may determine whether or not the luminance has increased by determining whether or not the facial expression of the driver is mapped to a strained face of the driver previously set. Alternatively, the luminance meter 11 may measure the luminance mapped to the changes in the size of the driver's eyes obtained using an image sensor, using a luminance table depending on the changes in the size of the driver's eyes.

In addition, the luminance meter 11 may measure the luminance using the luminance sensor and the above-described image information.

The excessive luminance determiner 12 may determine whether or not the incident light is excessive on the basis of the luminance measured by the luminance meter 11. Specifically, the excessive luminance determiner 12 may compare the luminance measured by the luminance meter 11 with an allowable threshold luminance. If the value of luminance measured by the luminance meter 11 is higher than the allowable threshold luminance, the excessive luminance determiner 12 may determine that the incident light is excessive. If the value of luminance measured by the luminance meter 11 is equal to or lower than the allowable threshold luminance, the excessive luminance determiner 12 may determine that the incident light is not excessive.

The preceding vehicle detector 20 may detect the preceding vehicle in front of the host vehicle, detect a relative speed of the preceding vehicle, and detect a vehicle-to-vehicle distance between the host vehicle and the preceding vehicle. The preceding vehicle detector 20 may be implemented as at least one of an ultrasonic sensor, a radar, a lidar, a camera, or combinations thereof.

The preceding vehicle detector 20 may detect the preceding vehicle using information received from the image sensor disposed on the vehicle to observe the outside of the vehicle and capture image data from the view and a processor configured to process the image data captured by the image sensor. At least one image sensor may be mounted on each portion of the vehicle to observe the front, side, or rear of the vehicle. For example, the image sensor and the processor may be provided as a single camera sensor.

In addition, the image sensor may be disposed on the vehicle to observe the outside of the host vehicle and configured to capture image data from the outside view. The image data captured by the image sensor may be processed by the processor to be used, together with the result of the detection of the excessive incident light, to control the acceleration and deceleration of the host vehicle and the vehicle-to-vehicle distance between the host vehicle and the preceding vehicle traveling in front of the host vehicle.

The processor may operate to process the image data captured by the image sensor. The processor may be implemented using at least one of electronic units able to process image data and perform other functions. For example, the processor may be implemented using at least one selected from among, but not limited to, an application specific integrated circuit (ASIC), a digital signal processor (DSP), a digital signal processing device (DSPD), a programmable logic device (PLD), a field programmable gate array (FPGA), a processor, a controller, a micro controller, a micro-processor, or combinations thereof.

The radar sensor or the radar system may include at least one radar sensor unit, e.g. at least one selected from among, but not limited to, a front detection radar sensor disposed on a front portion of the vehicle, a rear detection radar sensor disposed on a rear portion of the vehicle, a side radar sensor disposed on a side portion of the vehicle, a side-rear radar sensor disposed on a side-rear portion of the vehicle, or combinations thereof. The radar sensor or the radar system may perform data processing by analyzing transmission signals and reception signals, thereby detecting information regarding objects, and may include an electronic control unit (ECU) in this regard. Data transmission or signal communication from the ECU to the radar sensor may be performed via a communication link, such as a suitable vehicle network bus.

The controller 400 may control the overall operation of the adaptive cruise control system. For example, the controller may be implemented using an ECU. The controller may receive a result of the processing of the image data from the processor. The controller may include the acceleration, deceleration, and vehicle-to-vehicle distance controller 30 controlling the vehicle-to-vehicle distance between the preceding vehicle and the host vehicle, on the basis of at least the processing of the image data.

The acceleration, deceleration, and vehicle-to-vehicle distance controller 30 may control the acceleration and deceleration of the host vehicle and the vehicle-to-vehicle distance between the preceding vehicle and the host vehicle, on the basis of the result of the detection of the excessive incident light by the excessive incident light detector 10. The acceleration, deceleration, and vehicle-to-vehicle distance controller 30 may include an acceleration, deceleration, and vehicle-to-vehicle distance setter 31, an engine controller 32, and a brake controller 33.

If the preceding vehicle detector 20 has detected the preceding vehicle, the acceleration, deceleration, and vehicle-to-vehicle distance setter 31 may set acceleration and deceleration values of the host vehicle and a distance between the host vehicle and the preceding vehicle, on the basis of the result of the detection of the excessive incident light by the excessive incident light detector 10.

The engine controller 32 may accelerate the vehicle by controlling the engine providing propulsion to the vehicle, on the basis of the acceleration and deceleration values of the host vehicle and the distance between the host vehicle and the preceding vehicle set by the acceleration, deceleration, and vehicle-to-vehicle distance setter 31.

The brake controller 33 may decelerate the vehicle by controlling the brake providing braking force to the vehicle, on the basis of the acceleration and deceleration values of the host vehicle and the distance between the host vehicle and the preceding vehicle set by the acceleration, deceleration, and vehicle-to-vehicle distance setter 31.

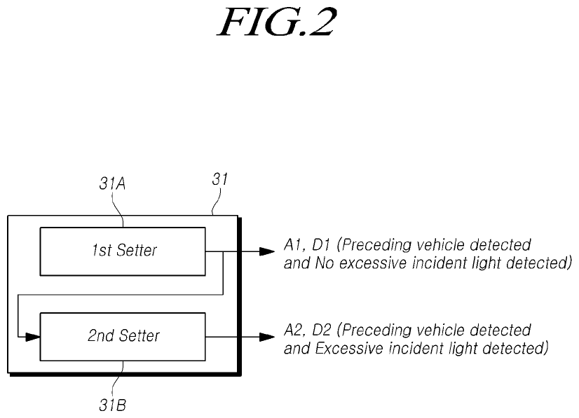

FIG. 2 is a block diagram of the acceleration, deceleration, and vehicle-to-vehicle distance setter 31 illustrated in FIG. 1.

Referring to FIG. 2, the acceleration, deceleration, and vehicle-to-vehicle distance setter 31 may include a first setter 31A and a second setter 31B.

The first setter 31A may set the vehicle-to-vehicle distance between the host vehicle and the preceding vehicle as a first vehicle-to-vehicle distance D1 and acceleration and deceleration values of the host vehicle as first acceleration and deceleration values A1.

The first setter 31A may obtain the first vehicle-to-vehicle distance D1 using a known vehicle-to-vehicle distance setting algorithm, wherein the vehicle-to-vehicle distance is set without consideration of the luminance of incident light. According to the embodiment, the adaptive cruise control system may include a memory (not shown) in which a plurality of vehicle-to-vehicle distances increasing with increases in the level are stored, and the first setter 31A may select a specific level using the known vehicle-to-vehicle distance setting algorithm and obtain the first vehicle-to-vehicle distance D1 from the memory in accordance with the selected level.

In addition, the first setter 31A may calculate specific acceleration and deceleration values required for maintaining the vehicle-to-vehicle distance, detected by the preceding vehicle detector 20, to be the first vehicle-to-vehicle distance D1, and set the calculated acceleration and deceleration values to be the first acceleration and deceleration values A1.

The second setter 31B may select one level from among levels higher than the level selected by the first setter 31A and may obtain a second vehicle-to-vehicle distance D2 using the selected level. Since the vehicle-to-vehicle distance of a higher level is greater than the vehicle-to-vehicle distance of a lower level, the second vehicle-to-vehicle distance D2 is greater than the first vehicle-to-vehicle distance D1.

The second setter 31B may select a level, which is one level higher than the level selected by the first setter 31A. That is, the level difference between the level selected by the second setter 31B and the level selected by the first setter 31A may be one (1). In addition, the level difference between the level selected by the second setter 31B and the level selected by the first setter 31A may increase in proportion to the luminance of incident light measured by the luminance meter 11. In this case, the second vehicle-to-vehicle distance D2 increases in proportion to the incident light measured by the luminance meter 11. Accordingly, in a case in which the vision of the driver is increasingly obstructed by the increasing luminance of incident light entering the cabin of the host vehicle, the increment of the vehicle-to-vehicle distance between the host vehicle and the preceding vehicle may be increased, thereby improving the safety of the driver.

In addition, the second setter 31B may calculate acceleration and deceleration values required for maintaining the vehicle-to-vehicle distance, detected by the preceding vehicle detector 20, to be the second vehicle-to-vehicle distance D2, and set the calculated acceleration and deceleration values to be second acceleration and deceleration values A2.

Both the first acceleration and deceleration values A1 and the first vehicle-to-vehicle distance D1 determined by the first setter 31A and the second acceleration and deceleration values A2 and the second vehicle-to-vehicle distance D2 determined by the second setter 31B should be values within allowable ranges of the adaptive cruise control system.

Hereinafter, the acceleration, deceleration, and vehicle-to-vehicle distance controller 30 setting the acceleration and deceleration values and the vehicle-to-vehicle distance will be described again, without discrimination of the first setter 31A and the second setter 31B. Since the first setter 31A and the second setter 31B, as described above, are logical components of the acceleration, deceleration, and vehicle-to-vehicle distance controller 30, the acceleration, deceleration, and vehicle-to-vehicle distance controller 30 may perform the operations of both the first setter 31A and the second setter 31B described above.

For example, if the excessive incident light is not detected by the excessive incident light detector, the acceleration, deceleration, and vehicle-to-vehicle distance controller 30 controls the acceleration and deceleration of the host vehicle on the basis of predetermined first acceleration and deceleration values, and controls the vehicle-to-vehicle distance between the host vehicle and the preceding vehicle on the basis of a predetermined first vehicle-to-vehicle distance. Here, the first acceleration and deceleration values may be determined by the driver when the adaptive cruise control system of the vehicle is started, or may be values set in the vehicle.

If the excessive incident light is detected by the excessive incident light detector, the acceleration, deceleration, and vehicle-to-vehicle distance controller 30 may control the acceleration and deceleration of the host vehicle to be the second acceleration and deceleration values different from the first acceleration and deceleration values the vehicle-to-vehicle distance of the host vehicle to be the second vehicle-to-vehicle distance greater than the first vehicle-to-vehicle distance.

In an example, the second acceleration and deceleration values may be set such that the deceleration increases and the acceleration decreases, compared to the first acceleration and deceleration values. That is, since the vision of the driver may be obstructed in this case, the deceleration value may be increased so that the host vehicle may be controlled to be more rapidly decelerated to a target speed. In addition, the acceleration value may be reduced so that the host vehicle may be controlled to be more slowly accelerated to a target speed.

In another example, the second acceleration and deceleration values and the second vehicle-to-vehicle distance may be mapped to and varied depending on the level of excessive incident light. That is, the variations of the acceleration and deceleration values and the vehicle-to-vehicle distance may be dynamically controlled depending on the level of the excessive incident light.

In addition, if the acceleration and deceleration values of the host vehicle are set to be the second acceleration and deceleration values and the vehicle-to-vehicle distance is set to be the second vehicle-to-vehicle distance, the acceleration, deceleration, and vehicle-to-vehicle distance controller 30 may change a reference distance for determining a point in time at which an alarm regarding collision with the preceding vehicle is to be generated. For example, even in the case in which the cruise control system is active, a collision alarm may be generated if there is a possibility of collision with the preceding vehicle or there is a risk of collision. Here, the point in time of the collision alarm may be dynamically controlled in accordance with whether or not the above-described excessive incident light is detected.

Specifically, if the excessive incident light has been detected, the reference distance with respect to the preceding vehicle for determining the point in time of the collision alarm may be increased, so that the collision alarm may be generated earlier than a point in time at which the collision alarm is generated with no excessive light being incident (e.g. in a case in which a longer vehicle-to-vehicle distance is maintained between the host vehicle and the preceding vehicle).

The adaptive cruise control system according to the disclosure may include: the excessive incident light detector detecting whether or not excessive incident light enters the cabin of the vehicle; the preceding vehicle detector including the image sensor disposed on the host vehicle to observe the outside of the host vehicle and configured to capture image data; and a domain control unit (DCU) detecting the preceding vehicle on the basis of at least the processing of the image data and controlling at least one driver assistance system provided in the host vehicle.

For example, the processor for processing the image data and the controller described above, as well as controllers for a variety of devices provided in the vehicle, may be integrated together to provide the domain control unit. In this case, the domain control unit may control the driver assistance system provided in the vehicle and a variety of related devices of the vehicle by generating a variety of vehicle control signals.

The domain control unit may control the acceleration and deceleration of the host vehicle and the vehicle-to-vehicle distance between the host vehicle and the preceding vehicle driving in front of the host vehicle, on the basis of the result of the detection of the excessive incident light by the excessive incident light detector. For this processing, the domain control unit may include at least one processor.

The domain control unit may be provided in the vehicle to communicate with at least one image sensor and at least one non-image sensor disposed on the vehicle. In this regard, a suitable data link or communication link, such as a vehicle network bus, for data transmission or signal communication, may be further provided.

The domain control unit may operate to control one or more among a variety of driver assistance systems (DAS) used in the vehicle. The domain control unit may control driver assistance systems (DAS), such as a blind spot detection (BSD) system, an adaptive cruise control (ACC) system, a lane departure warning system (LDWS), and a lane keeping assistance system (LKAS), on the basis of sensing data obtained by a plurality of non-image sensors and image data captured by the image sensor.

The domain control unit may control the acceleration and deceleration of the host vehicle and the vehicle-to-vehicle distance between the host vehicle and the preceding vehicle, on the basis of the result of the detection of the excessive incident light by the excessive incident light detector 10. If the preceding vehicle detector 20 has detected the preceding vehicle, the domain control unit may set the acceleration and deceleration values of the host vehicle and the vehicle-to-vehicle distance between the host vehicle and the preceding vehicle, on the basis of the result of the detection of the excessive incident light by the excessive incident light detector 10.

The domain control unit may accelerate the vehicle by controlling the engine providing propulsion to the vehicle, on the basis of the set acceleration and deceleration values and the set vehicle-to-vehicle distance.

The domain control unit may decelerate the vehicle by controlling the brake providing braking force to the vehicle, on the basis of the set acceleration and deceleration values and the set vehicle-to-vehicle distance.

The domain control unit may include the first setter 31A and the second setter 31B.

The first setter 31A may set the vehicle-to-vehicle distance between the host vehicle and the preceding vehicle to be the first vehicle-to-vehicle distance D1 and the acceleration and deceleration values of the host vehicle to the first acceleration and deceleration values A1.

The first setter 31A may obtain the first vehicle-to-vehicle distance D1 using a known vehicle-to-vehicle distance setting algorithm, wherein the vehicle-to-vehicle distance is set without consideration of the luminance of incident light. According to the embodiment, the adaptive cruise control system may include a memory (not shown) in which a plurality of vehicle-to-vehicle distances increasing with increases in the level are stored, and the first setter 31A may select a specific level using the known vehicle-to-vehicle distance setting algorithm and obtain the first vehicle-to-vehicle distance D1 from the memory in accordance with the selected level.

In addition, the first setter 31A may calculate specific acceleration and deceleration values required for maintaining the vehicle-to-vehicle distance, detected by the preceding vehicle detector 20, to be the first vehicle-to-vehicle distance D1, and set the calculated acceleration and deceleration values to be the first acceleration and deceleration values A1.

The second setter 31B may select one level from among levels higher than the level selected by the first setter 31A and may obtain the second vehicle-to-vehicle distance D2 using the selected level. Since the vehicle-to-vehicle distance of a higher level is greater than the vehicle-to-vehicle distance of a lower level, the second vehicle-to-vehicle distance D2 is greater than the first vehicle-to-vehicle distance D1.

The second setter 31B may select a level, which is one level higher than the level selected by the first setter 31A. That is, the level difference between the level selected by the second setter 31B and the level selected by the first setter 31A may be 1. In addition, the level difference between the level selected by the second setter 31B and the level selected by the first setter 31A may increase in proportion to the luminance of incident light measured by the luminance meter 11. In this case, the second vehicle-to-vehicle distance D2 increases in proportion to the incident light measured by the luminance meter 11. Accordingly, in a case in which the vision of the driver is more obstructed by the increasing luminance of incident light entering the cabin of the host vehicle, the increment of the vehicle-to-vehicle distance between the host vehicle and the preceding vehicle may be increased, thereby improving the safety of the driver.

In addition, the second setter 31B may calculate the acceleration and deceleration values required for maintaining the vehicle-to-vehicle distance, detected by the preceding vehicle detector 20, to be the second vehicle-to-vehicle distance D2, and set the calculated acceleration and deceleration values to be second acceleration and deceleration values A2.

Both the first acceleration and deceleration values A1 and the first vehicle-to-vehicle distance D1 determined by the first setter 31A and the second acceleration and deceleration values A2 and the second vehicle-to-vehicle distance D2 determined by the second setter 31B should be values within allowable ranges of the adaptive cruise control system.

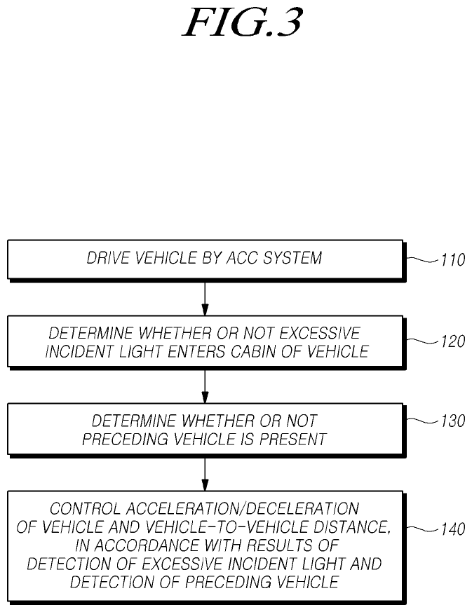

Hereinafter, an adaptive cruise control method of the above-described adaptive cruise control system according to the embodiment will be described with reference to FIG. 3. Although the adaptive cruise control method will be described as being performed by the controller, the present disclosure is not limited thereto. In the following description, the operation of the controller may be performed by the domain control unit substantially in the same manner, except for inapplicable features.

FIG. 3 is a flowchart illustrating the adaptive cruise control method according to the embodiment.

Referring to FIG. 3, the adaptive cruise control method according to the embodiment may include steps 110 to 140.

In the step 110, an adaptive cruise control mode is selected by a driver, so that the host vehicle is driven by the adaptive cruise control system.

If there is no preceding vehicle traveling in front of the host vehicle, the adaptive cruise control system may control the host vehicle to travel at a constant speed set by the driver (constant speed driving mode). If there is a preceding vehicle, the adaptive cruise control system may control the host vehicle to maintain a first vehicle-to-vehicle distance D1 from the preceding vehicle (guided driving mode).

In the step 120, the excessive incident light detector 10 may measure the luminance of incident light entering the front portion of the cabin of the host vehicle, and may determine whether or not the incident light is excessive on the basis of the luminance measured thereby.

In the step 130, the preceding vehicle detector 20 may detect the preceding vehicle traveling in front of the host vehicle, and may detect a relative speed of the detected preceding vehicle and a vehicle-to-vehicle distance between the host vehicle and the preceding vehicle.

In the step 140, if the preceding vehicle detector 20 has detected the preceding vehicle, the acceleration, deceleration, and vehicle-to-vehicle distance controller 30 may control the acceleration and deceleration of the host vehicle and the vehicle-to-vehicle distance between the host vehicle and the preceding vehicle, on the basis of the result of the detection of the excessive incident light by the excessive incident light detector 10.

Specifically, if the preceding vehicle detector 20 has detected the preceding vehicle and the excessive incident light detector 10 has not detected the excessive incident light, the acceleration, deceleration, and vehicle-to-vehicle distance controller 30 may control the engine and the brake of the host vehicle so that the host vehicle travels in accordance with first acceleration and deceleration values A1 and the first vehicle-to-vehicle distance D1 provided from the first setter 31A.

In addition, if the preceding vehicle detector 20 has detected the preceding vehicle and the excessive incident light detector 10 has detected the excessive incident light, the acceleration, deceleration, and vehicle-to-vehicle distance controller 30 may control the engine and the brake of the host vehicle so that the host vehicle travels in accordance with second acceleration and deceleration values A2 and a second vehicle-to-vehicle distance D2 provided from the second setter 31B.

Here, the second vehicle-to-vehicle distance D2 is a value greater than the first vehicle-to-vehicle distance D1, while the second acceleration and deceleration values A2 are values different from the first acceleration and deceleration values A1, in which the deceleration increases the acceleration decreases.

In addition, if the preceding vehicle detector 20 has not detected the preceding vehicle, the adaptive cruise control system may control the engine and the brake of the host vehicle so that the host vehicle travels at the predetermined constant speed.

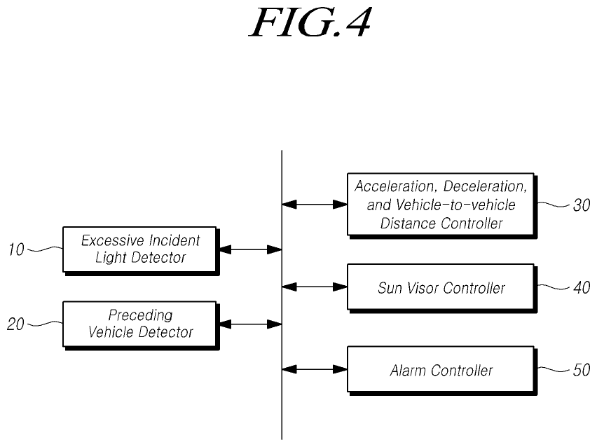

FIG. 4 is a block diagram illustrating a schematic configuration of an adaptive cruise control system according to another embodiment.

Referring to FIG. 4, the adaptive cruise control system according to the embodiment has a structure in which a sun visor controller 40 and an alarm controller 50 are further provided, in addition to the structure of the adaptive cruise control system described above with reference to FIG. 1.

Accordingly, the components other than the sun visor controller 40 and the alarm controller 50 are substantially the same as the components of the adaptive cruise control system described above with reference to FIG. 1, and thus, descriptions of the same components will be omitted.

The sun visor controller 40 may operate a sun visor disposed on the host vehicle, on the basis of the result of the detection of the excessive incident light by the excessive incident light detector 10. Specifically, if the excessive incident light detector 10 has detected the excessive incident light, the sun visor controller 40 may operate the sun visor to block the incident light. The sun visor controller 40 may include a drive unit, such as a motor or an actuator.

The alarm controller 50 may control an alarm device to generate an alarm message, on the basis of the result of the detection of the excessive incident light by the excessive incident light detector 10 and the result of the detection of the preceding vehicle by the preceding vehicle detector 20. Specifically, if the excessive incident light detector 10 has detected the excessive incident light and the preceding vehicle detector 20 has detected the preceding vehicle, the alarm controller 50 may operate the alarm device to attract the attention of the driver, so that the driver can drive safely.

Although the present embodiment has been described as including both the sun visor controller 40 and the alarm controller 50 with reference to FIG. 4, only one of the sun visor controller 40 and the alarm controller 50 may be provided.

Hereinafter, an adaptive cruise control method of the adaptive cruise control system according to the other embodiment, illustrated in FIG. 4, will be described.

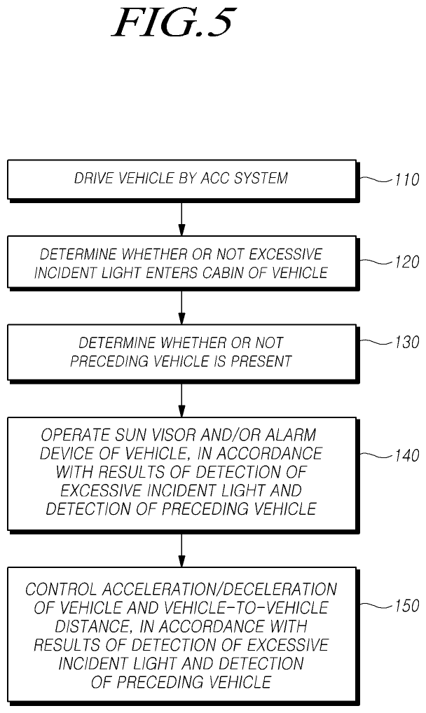

FIG. 5 is a flowchart illustrating the adaptive cruise control method according to the other embodiment.

The adaptive cruise control method according to the other embodiment illustrated in FIG. 5 further includes step 140 in comparison to the adaptive cruise control method described above with reference to FIG. 3. In addition, step 150 in FIG. 5 is the same as the step 140 of the adaptive cruise control method illustrated in FIG. 3.

Accordingly, the adaptive cruise control method of the other embodiment is substantially the same as the adaptive cruise control method described above with reference to FIG. 3, and thus, descriptions of the same features will be omitted.

Referring to FIG. 5, in the step 140, the sun visor controller 40 may operate the sun visor disposed on the host vehicle, on the basis of the result of the detection of the excessive incident light by the excessive incident light detector 10. In addition, the alarm controller 50 may operate the alarm device disposed on the host vehicle, on the basis of the result of the detection of the excessive incident light by the excessive incident light detector 10 and the result of the detection of the preceding vehicle by the preceding vehicle detector 20.

Specifically, if the excessive incident light detector 10 has detected the excessive incident light, the sun visor controller 40 may operate the sun visor disposed on the host vehicle to block light incident on the cabin of the host vehicle. If the excessive incident light detector 10 has detected the excessive incident light and the preceding vehicle detector 20 has detected the preceding vehicle, the alarm controller 50 may operate the alarm device disposed on the host vehicle to generate an alarm message.

Although the other embodiment illustrated in FIG. 5 has been described that both the sun visor controller 40 and the alarm controller 50 are operative in the step 140, only one of the sun visor controller 40 and the alarm controller 50 may be operated.

As set forth above, according to exemplary embodiments, when an excessive intensity of incident light enters the cabin of a host vehicle, the host vehicle can be automatically decelerated to increase a distance from a preceding vehicle, thereby improving the safety of a driver in a situation in which the vision of a driver may be obstructed by the excessive intensity of incident light.

According to exemplary embodiments, in a situation in which the luminance of incident light is excessive, a sun visor may be operated so that the vision of the driver may not be obstructed, thereby assisting in safe driving by the driver.

According to exemplary embodiments, when the luminance of incident light is excessive, an alarm message may be output to attract the attention of the driver, so that the driver can drive safely.

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

What is claimed is:

1. An adaptive cruise control system comprising:
an excessive incident light detector detecting whether or not incident light entering a host vehicle is excessive;
a preceding vehicle detector detecting a preceding vehicle traveling in front of the host vehicle using a sensor provided on the host vehicle; and
an acceleration, deceleration, and vehicle-to-vehicle distance controller controlling acceleration and deceleration of the host vehicle and a vehicle-to-vehicle distance between the host vehicle and the preceding vehicle, in accordance with a result of the detection of whether or not the incident light is excessive by the excessive incident light detector.

2. The adaptive cruise control system according to claim 1, wherein, if the preceding vehicle detector has detected the preceding vehicle, the acceleration, deceleration, and vehicle-to-vehicle distance controller controls the acceleration and deceleration of the host vehicle and the vehicle-to-vehicle distance between the preceding vehicle and the host vehicle, in accordance with the result of the detection of whether or not the incident light is excessive by the excessive incident light detector.

3. The adaptive cruise control system according to claim 1, wherein the excessive incident light detector includes:
a luminance meter measuring a luminance of the incident light; and
an excessive luminance determiner determining whether or not the incident light is excessive by comparing the luminance measured by the luminance meter and an allowable threshold luminance.

4. The adaptive cruise control system according to claim 3, wherein the luminance meter measures the luminance in accordance with information regarding the incident light collected using a luminance sensor disposed on a room mirror of the host vehicle.

5. The adaptive cruise control system according to claim 3, wherein the luminance meter measures the luminance by detecting a size variation of a pupil of a driver using image information received from a camera sensor capturing the driver in the host vehicle.

6. The adaptive cruise control system according to claim 3, wherein the luminance meter measures the luminance by detecting a variation in a facial expression of the driver or changes in the size of the driver's eyes using image information received from a camera sensor capturing the driver in the host vehicle.

7. The adaptive cruise control system according to claim 1, wherein, if the excessive incident light detector has not detected that the incident light is excessive, the acceleration, deceleration, and vehicle-to-vehicle distance controller controls the acceleration and deceleration of the host vehicle in accordance with first acceleration and deceleration values and controls the vehicle-to-vehicle distance of the host vehicle to be a first vehicle-to-vehicle distance, and
if the excessive incident light detector has detected that the incident light is excessive, the acceleration, deceleration, and vehicle-to-vehicle distance controller controls the acceleration and deceleration of the host vehicle to be second acceleration and deceleration values different from the first acceleration and deceleration values and controls the vehicle-to-vehicle distance of the host vehicle to be a second vehicle-to-vehicle distance greater than the first vehicle-to-vehicle distance.

8. The adaptive cruise control system according to claim 7, wherein the second acceleration and deceleration values are set such that the deceleration increases and the acceleration decreases, in comparison to the first acceleration and deceleration values.

9. The adaptive cruise control system according to claim 7, wherein the second acceleration and deceleration values and the second vehicle-to-vehicle distance are mapped and set depending on a level of the incident light that has been detected to be excessive.

10. The adaptive cruise control system according to claim 7, wherein, if the acceleration and deceleration values of the host vehicle are set to be the second acceleration and deceleration values and the vehicle-to-vehicle distance is set to be the second vehicle-to-vehicle distance, the acceleration, deceleration, and vehicle-to-vehicle distance controller changes a reference distance for determining a point in time at which an alarm regarding collision with the preceding vehicle is to be generated.

11. The adaptive cruise control system according to claim 1, further comprising a sun visor controller operates a sun visor disposed on the host vehicle, in accordance with the result of the detection of whether or not the incident light is excessive by the excessive incident light detector.

12. An adaptive cruise control method comprising:
detecting whether or not incident light entering a host vehicle is excessive; and
controlling acceleration and deceleration of the host vehicle and a vehicle-to-vehicle distance between the host vehicle and a preceding vehicle, in accordance with a result of the detection of whether or not the incident light is excessive.

13. The adaptive cruise control method according to claim 12, wherein the controlling of the acceleration and deceleration, if the preceding vehicle detector has detected the preceding vehicle, controls the acceleration and deceleration of the host vehicle and the vehicle-to-vehicle distance between the preceding vehicle and the host vehicle, in accordance with the result of the detection of the incident light by the excessive incident light detector.

14. The adaptive cruise control method according to claim 12, wherein the detection of whether or not the incident light is excessive comprises:
measuring a luminance of the incident light; and
determining whether or not the incident light is excessive by comparing the measured luminance and an allowable threshold luminance.

15. The adaptive cruise control method according to claim 12, wherein the controlling of the acceleration and deceleration comprises:
if the incident light is not detected to be excessive, controlling the acceleration and deceleration of the host vehicle in accordance with first acceleration and deceleration values and controlling the vehicle-to-vehicle distance of the host vehicle to be a first vehicle-to-vehicle distance; and
if the incident light is detected to be excessive, controlling the acceleration and deceleration of the host vehicle to be second acceleration and deceleration values different from the first acceleration and deceleration values and controlling the vehicle-to-vehicle distance of the host vehicle to be a second vehicle-to-vehicle distance greater than the first vehicle-to-vehicle distance.

16. The adaptive cruise control method according to claim 15, wherein the second acceleration and deceleration values are set such that the deceleration increases and the acceleration decreases, in comparison to the first acceleration and deceleration values.
